(19) United States
(12) Patent Application Publication
(10) Pub. No.: US 2015/0161115 A1
(43) Pub. Date: Jun. 11, 2015

(54) SYSTEMS AND METHODS FOR PROVIDING CONTEXT BASED DEFINITIONS AND TRANSLATIONS OF TEXT

(71) Applicant: Google Inc., Mountain View, CA (US)

(72) Inventors: Alexander Jay Cuthbert, Oakland, CA (US); Chao Tian, Sunnyvale, CA (US); John Denero, San Francisco, CA (US); Keith Stevens, San Francisco, CA (US); Sarah Nguyen, Sunnyvale, CA (US)

(73) Assignee: Google Inc., Mountain View, CA (US)

(21) Appl. No.: 14/563,584

(22) Filed: Dec. 8, 2014

Related U.S. Application Data
(60) Provisional application No. 61/913,532, filed on Dec. 9, 2013.

(51) Int. Cl. G06F 17/28

(52) U.S. Cl. CPC G06F 17/289

(57) ABSTRACT

Systems and methods are provided for translating a phrase block and presenting meanings and translations of the phrase block. Consistent with certain embodiments, computer-implemented systems and methods are provided for identifying parts of speech of the phrase block, determining definitions of the phrase block in the source language corresponding to the parts of speech, and determining usage examples corresponding to the definitions. Additionally, systems and methods are provided for translating the phrase block from the source language to translated text and for ranking the parts of speech based on usage. Consistent with certain embodiments, computer-implemented systems and methods are also provided for determining usage based on a user's location, based on a corpus of documents, and/or based on content stored by the user. Systems and methods are also provided for displaying the phrase block, definitions and usage examples of the phrase block, and/or translations of the phrase block according to the ranking.

### CROSS-REFERENCE TO RELATED APPLICATIONS

This application claims the benefit of U.S. Provisional Application No. 61/913,532, filed on Dec. 9, 2013. The disclosure of the above application is incorporated herein by reference in its entirety.

### FIELD

The present disclosure relates to techniques for machine translation and, more particularly, to techniques for providing definitions and translations of text based on the text context.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The rapid growth and ease of accessibility of the Internet and web has enabled users to search for information conveniently, from any location, and using a variety of electronics or communication devices. When presented with content in an unfamiliar language, users often desire to obtain an automated translation of the content into a language they are familiar with or which they can understand.

Some words or phrases have a single meaning. However, in many cases, a word or phrase may have a range of possible meanings. Additionally, a single word can have more than one part-of-speech. For example, a single word like “brush” can have both a noun form and a verb form. As a result, translating by merely substituting words in one language with corresponding words in another language may not be sufficient because the correct translation may depend on the context in which the word is used.

### SUMMARY

In accordance with the present disclosure, computerized systems and methods are provided for providing context based definitions and translations of text or phrase blocks. Embodiments of the present disclosure relate to systems and methods for presenting the meaning of words and translations of the words in a variety of contexts, together with examples showing how the word may be used in the different contexts.

In accordance with certain embodiments, systems and methods are provided for identifying the parts-of-speech corresponding to a word or phrase, determining the most dominant parts-of-speech, and providing definitions and usage examples for the word or phrase for the dominant parts-of-speech. As disclosed herein, embodiments of the present disclosure may also present translations of the word or phrase in a second language identified by the user. Additionally, embodiments of the present disclosure may provide an indication of the frequency with which a particular word or phrase may be used in a particular context, for example, in a particular part-of-speech. Still further, embodiments of the present disclosure relate to systems and methods for presenting the definitions and translations to a user by leveraging the user's personal translation history and context of use. Still further embodiments of the present disclosure provide systems and methods for presenting the definitions and translations to the user in an organized and easy to read manner, for example, in the form of a summary, which may be expandable to provide more information about the word or phrase.

In accordance with one exemplary embodiment, a server system is provided for translating a phrase block. By way of example, the server comprises a memory device that stores a set of instructions; and one or more processors that execute the instructions to: receive a request for translation, the request comprising a phrase block; identify parts-of-speech of the phrase block; determine definitions of the phrase block, corresponding to the identified parts-of-speech, in the source language; determine usage examples for the phrase block, corresponding to the definitions, in the source language; translate, the phrase block from the source language to translated text in the target language, the translated text comprising one or more translations of the phrase block; rank the parts-of-speech in a first rank order based on usage of the parts-of-speech in the source language; generate display groups, each group including a part-of-speech selected from the parts-of-speech, one or more definition corresponding to the part-of-speech, and one or more usage examples corresponding to the definitions; determine the order for the display groups based on the first rank order; and transmit information sufficient for a device to render the display groups in the order and the translated text.

In accordance with another exemplary embodiment, a computer-implemented method is provided for translating a phrase block. By way of example, the method comprises the following operations performed by one or more processors, including: receiving, from a client device, a phrase block for translation from a source language to a target language; identifying a part-of-speech for the phrase block; determining a definition of the phrase block in the source language, the definition corresponding to the part-of-speech; determining a usage example for the phrase block in the source language, the usage example corresponding to the definition; translating the phrase block from the source language to translated text in the target language, the translated text corresponding to the part-of-speech; and generating a display of the phrase, the part-of-speech, the definition, the usage example, and the translated text.

In accordance with another exemplary embodiment, a computer-implemented method is provided for translating a phrase block. By way of example, the method comprises the following operations performed by one or more processors, including: receiving a phrase block for translation from a source language to a target language; identifying parts-of-speech corresponding to the phrase block; determining definitions of the word in the source language corresponding to the parts-of-speech; determining usage examples for the word in the source language corresponding to the definitions; translating the phrase block from the source language to translated text, corresponding to the parts-of-speech, in the target language; ranking the parts-of-speech in a first rank order based on usage of the parts-of-speech in the source language; generating display groups, each display group including: a part-of-speech selected from the parts-of-speech; definitions corresponding to the part-of-speech; usage examples corresponding to the definitions; and presenting, on a display device, the phrase block, and the display groups based on the first rank order.

In accordance with another exemplary embodiment, a computer program product is provided. By way of example the computer program product includes executable instructions tangibly embodied in a non-transitory computer-readable medium, which when executed by one or more processors, cause the one or more processors to perform a method including: receiving a phrase block for translation from a source language to a target language; identifying parts-of-speech corresponding to the phrase block; determining definitions of the word in the source language corresponding to the parts-of-speech; determining usage examples for the word in the source language corresponding to the definitions; translating the phrase block from the source language to translated text in the target language, corresponding to the parts-of-speech; ranking the parts-of-speech in a first rank order based on usage of the parts-of-speech in the source language; generating display groups, each display group including: a part-of-speech selected from the parts-of-speech; definitions corresponding to the part-of-speech; usage examples corresponding to the definitions; and presenting, on a display device, the phrase block, and the display groups based on the first rank order.

In accordance with one exemplary embodiment, a client is provided for translating a phrase block. By way of example, the client comprises a memory device that stores a set of instructions; and one or more processors that execute the instructions to: receive a request for translation, the request comprising a phrase block; identify parts-of-speech of the phrase block; determine definitions of the phrase block, corresponding to the identified parts-of-speech, in the source language; determine usage examples for the phrase block, corresponding to the definitions, in the source language; translate, the phrase block from the source language to translated text in the target language, the translated text comprising one or more translations of the phrase block; rank the parts-of-speech in a first rank order based on usage of the parts-of-speech in the source language; generate display groups, each group including a part-of-speech selected from the parts-of-speech, one or more definition corresponding to the part-of-speech, and one or more usage examples corresponding to the definitions; determine the order for the display groups based on the first rank order; and transmit information sufficient for a device to render the display groups in the order and the translated text.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an exemplary system environment for implementing embodiments and features of the present disclosure;

FIG. 2 illustrates an exemplary electronic apparatus or system for implementing embodiments and features of the present disclosure;

FIG. 3 is a flowchart of an exemplary process for providing definitions and translations of a word or phrase, which may have one part-of-speech;

FIG. 4 illustrates an exemplary user interface for presenting definitions and translations of a word or phrase when there is one part-of-speech;

FIG. 5 is a flowchart of an exemplary process for providing definitions and translations of a word or phrase, which may have two parts-of-speech;

FIG. 6 illustrates an exemplary user interface for presenting definitions and translations of a word or phrase when there are two parts-of-speech;

FIG. 7 illustrates another exemplary user interface for presenting definitions and translations of a word or phrase when there are two parts-of-speech;

FIG. 8 is a flowchart of an exemplary process for providing definitions and translations of a word or phrase, which may have more than two parts-of-speech; and

FIG. 9 illustrates an exemplary user interface for presenting definitions and translations of a word or phrase when there are more than two parts-of-speech.

### DETAILED DESCRIPTION

Reference will now be made in detail to the present exemplary embodiments of the present disclosure, examples of which are illustrated in the accompanying drawings. Wherever possible, the same reference numbers will be used throughout the drawings to refer to the same or like parts.

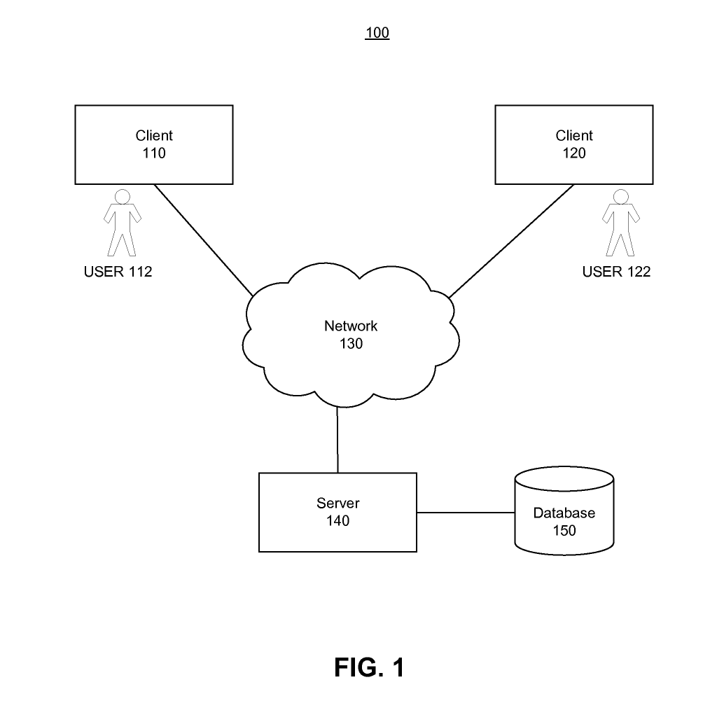

FIG. 1 is a block diagram of an exemplary system environment 100 for implementing embodiments and features of the present disclosure. The arrangement and number of components in system 100 is provided for purposes of illustration. Additional arrangements, number of components, and other modifications may be made, consistent with the present disclosure.

As shown in FIG. 1, system environment 100 may include one or more clients 110, 120 that are owned or operated by one or more users 112, 122. By way of example, clients 110, 120 may include smartphones, tablets, netbooks, electronic readers, personal digital assistants, personal computers, laptop computers, desktop computers, and/or other types of electronics or communication devices. In some embodiments, clients 110, 120 are implemented with hardware devices and/or software applications running thereon. In certain embodiments, client 110 or 120 may implement embodiments and features of the present disclosure without the need for accessing another device, component, or network, such as network 130. In other embodiments server 140 may implement embodiments and features of the present disclosure without the need for accessing another device, component, or network 130. In yet other embodiments, clients 110, 120 may be configured to communicate to and/or through network 130 with other clients and components, such as server 140 and database 150.

In certain embodiments, network 130 may include any combination of communications networks. For example, network 130 may include the Internet and/or any type of wide area network, an intranet, a metropolitan area network, a local area network (LAN), a wireless network, a cellular communications network, etc. In some embodiments, clients 110, 120 may be configured to transmit requests (e.g., requests based on input provided by users 112, 122) through network 130 to an appropriate server, such as, for example, server 140. In some embodiments, clients 110, 120 may also be configured to receive information, in response to the requests, from server 140 through network 130.

Server 140 may include one or more servers configured to communicate and interact with clients 110, 120, network 130, and/or database 150. In some embodiments, server 140 may implement or provide one or more search engines, dictionary services, translation services, dictionary engines, and/or translation engines. Server 140 may be a general-purpose computer, a mainframe computer, or any combination of these components. In certain embodiments, server 140 may be standalone computing system or apparatus, or it may be part of a subsystem, which may be part of a larger system. For example, server 140 may represent distributed servers that are remotely located and communicate over a communications medium (e.g., network 130) or over a dedicated network, for example, a LAN. Server 140 may be implemented as a server, a server system comprising a plurality of servers, or a server farm comprising a load balancing system and a plurality of servers.

Database 150 may include one or more logically and/or physically separate databases configured to store data. The data stored in database 150 may be received from servers 140, from clients 110, 120 and/or may be provided as input using conventional methods (e.g., data entry, data transfer, data uploading, etc.). The data stored in the database 150 may take or represent various forms including, but not limited to, documents, presentations, textual content, mapping and geographic information, rating and review information, pricing information, news, audio files, video files, and a variety of other electronic data, or any combination thereof. Database 150 may also include, for example, dictionary databases for one or more languages, and/or a corpus of content including documents, search logs, web pages, and/or social network content, etc.

In some embodiments, database 150 may be implemented using a single computer-readable storage medium. In other embodiments, database 150 may be maintained in a network attached storage device, in a storage area network, or combinations thereof, etc. Furthermore, database 150 may be maintained and queried using numerous types of database software and programming languages, for example, SQL, MySQL, IBM DB2®, Microsoft Access®, PERL, C/C++, Java®, etc. Although FIG. 1 shows database 150 associated with server 140, database 150 may be a standalone database that is accessible via network 130 or database 150 may be associated with or provided as part of a system or environment that may be accessible to clients 110, 120 and/or other components.

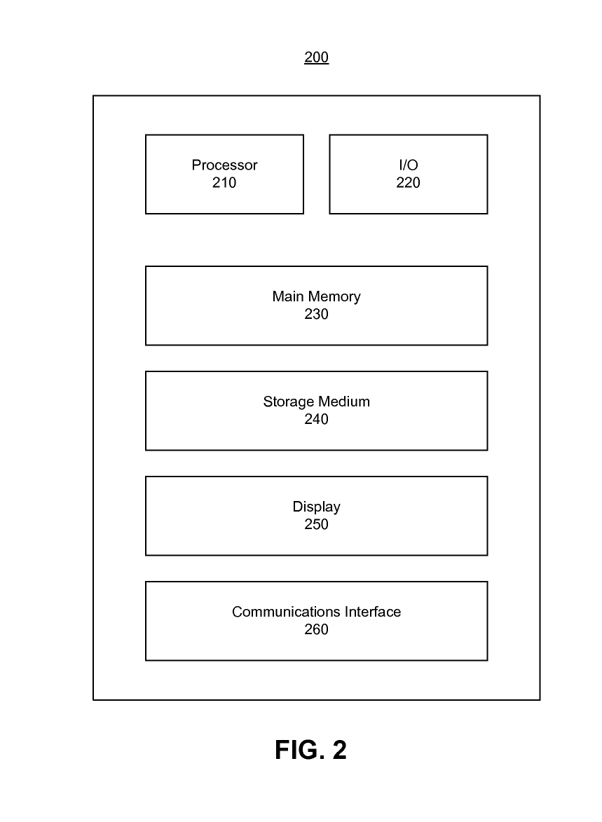

FIG. 2 is a block diagram of an exemplary electronic apparatus or system 200 for implementing embodiments and features of the present disclosure. By way of example, apparatus or system 200 may be used to implement clients 110, 120 and/or server 140 of FIG. 1. The arrangement and number of components in system 200 is provided for purposes of illustration. Additional arrangements, number of components, and other modifications may be made, consistent with the present disclosure.

As shown in FIG. 2, system 200 may include one or more processors 210 for executing instructions. System 200 may also include one or more input/output (I/O) devices 220. By way of example, I/O devices 220 may include physical keyboards, virtual touch-screen keyboards, mice, joysticks, styluses, etc. In certain embodiments, system 200 may also be capable of receiving input through a microphone (not shown) using, for example, voice recognition applications.

As further illustrated in FIG. 2, system 200 may include one or more storage devices configured to store data and/or software instructions used by the one or more processors 210 to perform operations consistent with disclosed embodiments. For example, system 200 may include main memory 230 configured to store one or more software programs that performs functions or operations when executed by the one or more processors 210. By way of example, main memory 230 may include NOR or NAND flash memory devices, Read Only Memory (ROM) devices, Random Access Memory (RAM) devices, etc. System 200 may also include storage medium 240. By way of example, storage medium 240 may include hard drives, solid state drives, tape drives, RAID arrays, etc. Although FIG. 2 shows only one main memory 230 and one storage medium 240, system 200 may include any number of main memories 230 and storage mediums 240. Further, although FIG. 2 shows main memory 230 and storage medium 240 as part of system 200, main memory 230 and/or storage medium 240 may be located remotely and system 200 may be able to access main memory 230 and/or storage medium 240 via network 130.

System 200 may also include one or more displays 250 for displaying data and information. Display 250 may be implemented using devices or technology, such as a cathode ray tube (CRT) display, a liquid crystal display (LCD), a plasma display, a light emitting diode (LED) display, a touch screen type display, and/or any other type of display known in the art.

System 200 may also include one or more communications interfaces 260. Communications interface 260 may allow software and data to be transferred between system 200, network 130, clients 110, 120, and/or other components. Examples of communications interface 260 may include a modem, a network interface (e.g., an Ethernet card), a communications port, a PCMCIA slot and card, etc. Communications interface 260 may transfer software and data in the form of signals, which may be electronic, electromagnetic, optical, or other signals capable of being received by communications interface 260. These signals may be provided to communications interface 260 via a communications path (not shown), which may be implemented using wire, cable, fiber optics, radio frequency (“RF”) link, and/or other communications channels.

The disclosed embodiments are not limited to separate programs or computers configured to perform dedicated tasks. For example, server 140 may include main memory 230 that stores a single program or multiple programs. Additionally, server 140 may execute one or more programs located remotely from server 140. For example, server 140 may access one or more remote programs stored in main memory 230 included within a component, for example, clients 110, 120 that, when executed, perform operations consistent with the disclosed embodiments. In some exemplary embodiments, server 140 may be capable of accessing separate web server(s) or computing devices that generate, maintain, and provide web site(s), dictionary services, and/or translation services. Clients 110, 120 may function in a manner similar to server 140 and vice-versa.

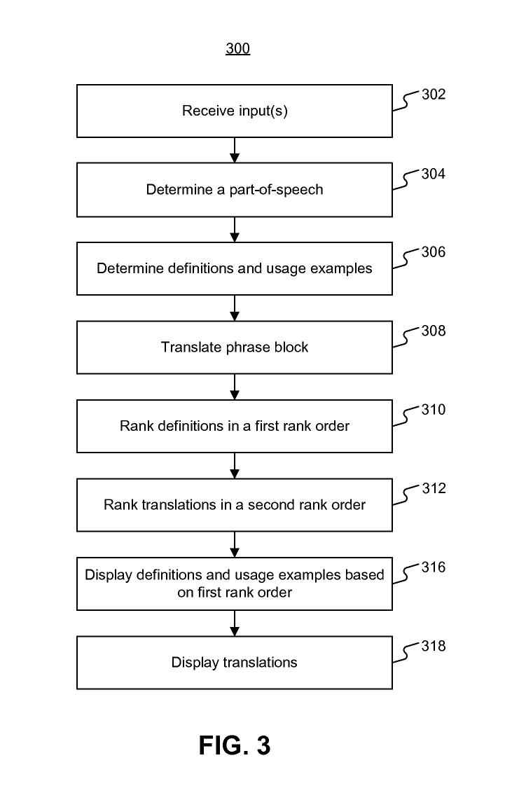

FIG. 3 is a flowchart of an exemplary process 300 that may be implemented for providing meanings and translations of a word or phrase, which may have one part-of-speech. Process 300 may be implemented on a client 110 or 120 without the need to access server 140 and/or network 130. Additionally or alternatively, process 300 may be implemented on server 140 without the need to access clients 110, 120 and/or network 130. In some embodiments, process 300 may be implemented using one or more of clients 110, 120, and/or server 140 communicating via network 130. The order and arrangement of steps in process 300 is provided for purposes of illustration. As will be appreciated from this disclosure, modifications may be made to process 300 by, for example, adding, combining, removing, and/or rearranging the steps for the process.

As used in this disclosure, a phrase block may include a single word, a phrase, and/or an inflected form. Generally, a phrase is between two and five words in length. By way of example, a single word, such as, “apple,” “run,” or “weave” may represent a phrase block. Further, by way of example, a phrase such as “good morning,” “bad weather,” etc., may represent a phrase block. Further still, for example, the sentence fragment “my hair is black,” may include two phrase blocks, namely “my hair” and “is black.”

As shown in FIG. 3, process 300 may include a step 302 of receiving one or more inputs. The inputs may include one or more phrase blocks for translation. Step 302 may include accessing or receiving a phrase block stored in database 150 or in another database associated with system 100. In one exemplary embodiment, a phrase block may be received by accessing phrase blocks stored in main memory 230 or storage medium 240 of clients 110, 120, and/or server 140. In another exemplary embodiment, a phrase block may be received in step 302, when a user 112, 122 inputs the phrase block using one or more of the I/O devices 220 associated with one or more clients 110, 120 or with server 140. In some exemplary embodiments, a phrase block may be received in step 302 in the form of a Uniform Resource Locator (“URL”) or other identifier, which can specify, e.g., a web page, a document, an image, or other resource.

As part of step 302, an indication of source and target languages may be received as input. The source language is a language from which a user may want to translate a phrase block. The target language is a language to which the user may want to translate the phrase block. By way of example, when a user wishes to translate a phrase block from “English” to “Spanish,” the source language is “English” and the target language is “Spanish.” Receiving indication of the source and target languages in step 302 may include receiving inputs of the source and target languages from a user 112, 122, who may use one or more of the I/O devices 220 or from clients 110, 120, or server 140. In one exemplary embodiment, a user interface may be provided with pull-down menus or drop-down boxes for selection of the source and/or target languages from a list of supported languages provided in the pull-down menus or drop-down boxes. Receiving an indication may include a user making a selection (e.g. using a computer mouse or other I/O devices 220). In another exemplary embodiment, a pull-down menu or drop-down box may provide a list of supported source language-target language pairs. By way of example, a source language-target language pair, such as, “English-to-German” or “Spanish-to-English” may be displayed on the user interface. Receiving an indication may include a user selecting one such pair (e.g., using a computer mouse or other I/O device 220). In another exemplary embodiment, receiving indication of the source and target languages may include accessing the source and target languages or source language-target language pairs stored in database 150 or in another database associated with system 100. In another exemplary embodiment, receiving indication of the source and target languages may include accessing the source and target languages or source language-target language pairs stored in one or more main memories 230 or storage mediums 240.

In some exemplary embodiments, the target language may be determined, for example, from a browser setting, information about a user, location information etc. Further, in some exemplary embodiments, the source language may be determined based on the dictionary database in which the phrase block may be found or by matching to language models associated with the dictionary database.

As further shown in FIG. 3, process 300 may also include a step 304 of determining a part-of-speech for the phrase block. For example, in step 304, it may be determined whether the phrase block received in step 302 is a noun, verb, adjective, adverb, etc. By way of example, the single word “apple” has only one part-of-speech, namely noun. Determining the part-of-speech in step 304 may include accessing a dictionary database and retrieving the part-of-speech information from the dictionary database. In another exemplary embodiment, determining the part-of-speech may include using a dictionary engine provided by clients 110, 120, and/or server 140. The dictionary engine may employ its own dictionary and/or other database to determine the part-of-speech for a phrase block.

Process 300 may also include a step 306 of determining one or more definitions of the phrase block in the source language, corresponding to the part-of-speech determined, for example, in step 304. Determining definitions of a phrase block may also include accessing definitions for the phrase block from a dictionary database or using a dictionary engine in a manner similar to that discussed above with respect to step 304. Determining the definitions of a phrase block may include identifying definitions of words or phrases related to the phrase block. For example, determining definitions for the word “apple” may include retrieving definitions for the word “apple” and the word “apple-tree.” Words or phrases related to the phrase block may be determined by examining how the phrase block is used in a corpus associated with the source language. As used in this disclosure a corpus may include, for example, documents, search logs, web pages, social network content, etc. By way of example, a first definition for the word apple may be provided as “the round fruit of a tree of the rose family, which typically has thin red or green skin and crisp flesh.” Further, by way of example, a second definition for the word “apple,” based on the meaning of the related word “apple-tree” may be provided as “a tree which bears apples.”

Determining the definitions of a phrase block may include determining the definitions for all parts-of-speech for that phrase block. For example, a phrase block may have a noun form, a verb form, an adjective form, an adverb form, etc. Determining the definitions in step 306 may include determining definitions corresponding to each part-of-speech of the phrase block. By way of example, the phrase block “run” has both a noun form and a verb form. Determining the definitions of “run” according to step 306 may include determining a first definition for a verb form as “move at a speed faster than walk,” and a second definition for a noun form as “an act or spell of running.” Although, only one definition for each part-of-speech is described above, determining the definitions in step 306 may include determining more than one definition, for each part-of-speech of the phrase block.

As part of step 306, usage examples may be determined for each of the determined definitions. Determining usage examples for each definition may include accessing the usage examples from a dictionary database or using a dictionary engine to retrieve usage examples from a database associated with the dictionary engine. Further, determining usage examples for each definition may include examining a corpus associated with the source language to retrieve sentences showing usage of the phrase block.

As shown in FIG. 3, process 300 may also include a step 308 of translating a phrase block from a source language into a target language. Translating may include accessing a dictionary database for the target language and retrieving translated text corresponding to the phrase block from the dictionary database associated with the target language. The translated text may include many items each representing a translation of the phrase block. The translated text may correspond to a part-of-speech of the phrase block identified, for example, in step 304. In one exemplary embodiment, translated text corresponding to a “noun” form may include both masculine and feminine forms in the target language. The dictionary database associated with the target language may be stored in database 150, memory 230, storage medium 240 or in some remote database connected to network 130. In another exemplary embodiment, the dictionary database associated with the target language may be stored on clients 110, 120. In yet another exemplary embodiment, translating the phrase block may include using a dictionary engine, associated with the target language, provided by clients 110, 120, and/or server 140. The dictionary engine may employ its own dictionary or other database associated with the target language to obtain translated text in the target language.

Process 300 may also include a step 310 of ranking definitions in a first rank order. Ranking a definition may include determining a frequency of use of the phrase block corresponding to that definition. In some exemplary embodiments, ranking may include determining the number of times a phrase block is used in the corpus corresponding to each definition of the phrase block. Different definitions of the phrase block may then be ranked based on the frequency of use of the phrase block corresponding to each definition. In one exemplary embodiment, a definition may have a higher rank if more instances of use of the phrase block corresponding to that definition are identified in the corpus. By way of example, more frequent use of the word “apple” to mean a fruit in the corpus may result in that definition of “apple” having a higher rank compared to the definition as “a tree which bears apples.”

In one exemplary embodiment, ranking the definitions may include examining information related to the user, for example, location of the user at the time the user requests a translation. Location of the user may be determined in many ways. In one exemplary embodiment, location of the user may be determined by triangulating a distance of clients 110, 120 or other devices being used by the user from locations of cellular or wireless transmission sites associated with network 130. In another exemplary embodiment, location of the user may be determined based on information from global positioning signals transmitted or received by clients 110, 120 or other devices being used by the user. In another exemplary embodiment, an internet protocol (IP) address of clients 110, 120, server 140, and/or other components or devices being used by users 112, 122 may be used to determine the location of the user. In yet another exemplary embodiment, the location of the user may be determined from information provided by clients 110, 120, user 112, 122 via one or more I/O devices 220 associated with clients 110, 120, or server 130, or via other devices being used by the user.

Definitions corresponding to a user's geographical location at the time the user requests translation may be used to rank the definitions of a phrase block. By way of example, when a user is in a painting class, a definition of the word “brush” as “a device for painting” may receive a higher rank compared to a definition of “brush” as a “shrubbery” or vegetation. By way of another example, when a user requests translation of the word “train” while being located in a train station, a definition related to railroads may receive a higher rank compared to a definition of “train” related to pointing or aiming something, such as, a gun or camera at someone.

In some exemplary embodiments, ranking may include an examination of the local, colloquial, or slang usage of a phrase block in the geographical area in which the user may be located. For example, a definition may receive a higher ranking if an examination of the corpus indicates higher frequency of usage of that definition at or near the location of the user.

In other exemplary embodiments, ranking the definitions may include examining a user's personal translation history. For example, ranking may include examining recent translation requests made by the user. By way of example, if a user has recently searched for information associated with cooking, a subsequent search for “chicken” may rank definitions of the word chicken associated with “poultry” higher than definitions related to, for example, “being scared.”

In yet another exemplary embodiment, ranking the definitions may include examining content stored by the user on clients 110, 120 or server 140, for example, in a personal phrase book. By way of example, the word “run” may have a first definition as “moving at a speed faster than a walk” and a second definition as “manage or direct.” Initially, the more common usage as exemplified by the first definition may receive a higher rank. The ranking may, however, change based on content stored in the user's phrasebook. For example, if the user has saved phrases, such as, “the president appears to run the country,” the second definition of run as “manage or direct” may receive a higher ranking compared to the first definition as “moving at a speed faster than a walk.” Thus, ranking of the definitions of a phrase block may be based on frequency of usage, or on contextual information such as the user's location, the user's translation history, or the user's preferences as determined by content stored by user 112 or 122.

Process 300 may also include a step 312 of ranking items in the translated text in a second rank order. Ranking items in the translated text may include determining a frequency of use of an item corresponding to a definition using processes similar to those described above with respect to step 310. In one exemplary embodiment, ranking an item in the translated text may include examining information related to the user, for example, location of the user at the time the user requests a translation using processes similar to those described above with respect to step 310. In another exemplary embodiment, ranking items in translated text may be based on a user's personal translation history. In yet another exemplary embodiment, ranking items in the translated text may be based on a corpus in the target language or may be based on textual content stored by the user in, for example, a phrasebook. Ranking items in the translated text based on a corpus, based on the user's translation history, or based on saved textual content may be performed using processes similar to those described above with respect to step 310.

Referring again to FIG. 3, process 300 may also include a step 316 of displaying definitions, in the source language, for the phrase block on a display 250 or other similar display device associated with clients 110, 120, server 140, or other device being used by the user. Definitions of the phrase block may be displayed according to the first rank order of the definitions determined in step 310. For example, definitions having a higher rank in the first rank order may be displayed near an upper portion of a display 250 and definitions having a lower rank may be displayed below the definitions having a higher rank. Further, only a selected few definitions having higher ranks in the first rank order may be displayed in on display 250. In one exemplary embodiment, only the first three definitions having the three highest ranks in order may be displayed on display 250. In some exemplary embodiments, an arrow, button, a link, etc., may be provided on a user interface displayed on display 250 to allow a user to iteratively unfold (i.e. display) more definitions.

Displaying definitions (step 316) may include displaying one or more usage examples associated with each definition. In one exemplary embodiment, a definition and a usage example associated with the definition may be displayed as a group adjacent to each other. In another exemplary embodiment, a display group may be generated. Each display group may include a definition selected from among the definitions of the phrase block. In addition, the display group may include one or more usage examples corresponding to the selected definition. In some exemplary embodiments, only one usage example may be provided for each definition. The display groups may be displayed in an order based on the first rank order of the definitions. For example, a first display group may be displayed above a second display group when the first display group includes a first definition with a higher rank compared to a second definition included in the second display group. In some exemplary embodiments, an arrow, button, a link, etc., may be provided on a user interface to allow the user to iteratively unfold (i.e. display) more than one display group for a phrase block.

Process 300 may also include a step 318 of displaying translations of the phrase block. Displaying translations may include displaying the translations according to the second rank order determined, for example, in step 312. For example, translations having a higher rank in the second rank order may be displayed near an upper portion of a display 250 and translations having a lower rank may be displayed below translations having a higher rank in the second rank order. Further, only a selected few translations may be displayed on display 250. In one exemplary embodiment, only the first five translations having the five highest ranks in the second rank order may be displayed on display 250. In some exemplary embodiments, an arrow, button, a link, etc., may be provided on a user interface displayed on display 250 to allow a user to iteratively unfold (i.e. display) more translations.

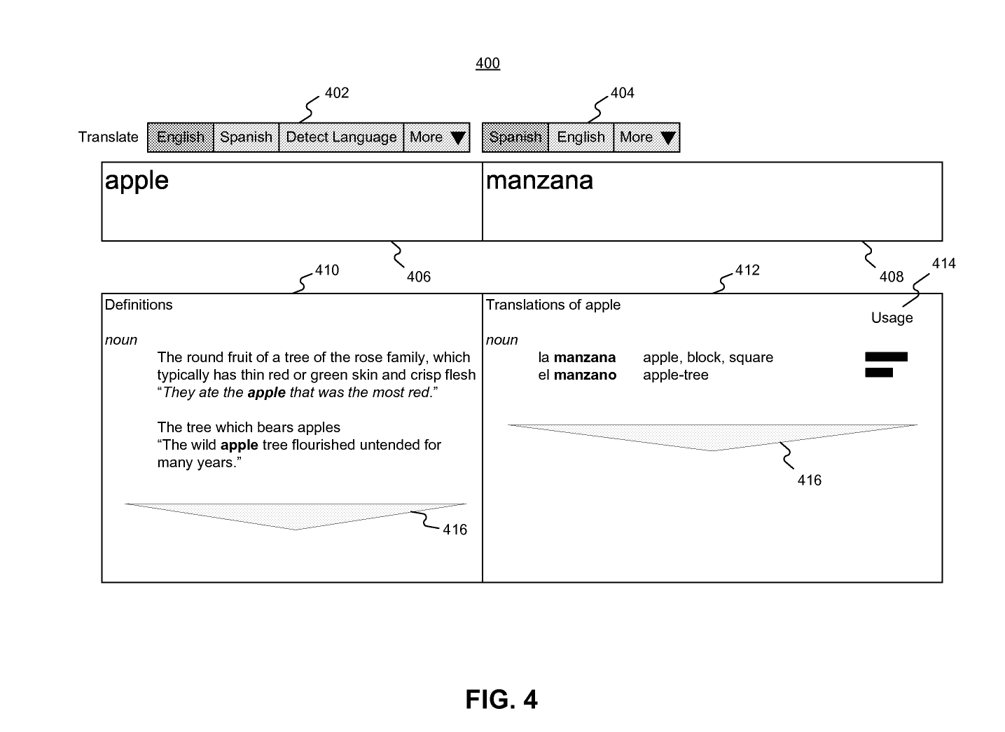

FIG. 4 illustrates an exemplary user interface 400. User interface 400 may present definitions and translations of a phrase block when the phrase block has a single part-of-speech, for example. As illustrated in FIG. 4, user interface 400 may include a display portion 402 for displaying a list of languages and menu items for selecting a source language. For example, as illustrated in FIG. 4, display portion 402 may include buttons displaying the languages “English” and “Spanish.” A user may select one of these two languages as a source language by clicking on the corresponding button using, for example, a mouse or other I/O devices 220. Display portion 402 may also include a menu item titled “Detect Language.” Clicking on this button may allow detection of the source language by examining the phrase block input by the user. In addition, display portion 402 may include a button titled “More” which may provide additional options, for example, a list of other supported languages, etc. Display portion 404 may similarly list languages available as target languages. In some exemplary embodiments, the source and target language may be highlighted using one or more colors to show that a user has selected a particular source and/or a target language.

User interface 400 may also include windows 406, 408, 410, and/or 412. Window 406 may be a source window and may be displayed adjacent an upper left corner of display 250. Window 406 may be displayed below display portion 402. Window 406 may display a phrase block received as input in step 302. Window 406 may display the phrase block in the source language selected by the user. For example, as shown in FIG. 4, window 406 displays the phrase block “apple” in the source language “English.”

Window 408 may be a target window and may be displayed adjacent window 406 near an upper right corner of display 250. Window 408 may be displayed below display portion 404. Window 408 may display translated text, for example, a translation of the phrase block in a target language selected by the user. For example, as shown in FIG. 4, window 408 displays the translated text “manzana” in the target language “Spanish.”

User interface 400 may also include a window 410 for showing definitions and usage examples of a phrase block in the source language. Window 410 may be displayed below window 406 adjacent a lower left corner of display 250. Window 410 may display the part-of speech for the phrase block. Window 410 may also display definitions of the phrase block, in the source language, according to the first rank order determined, for example, in step 310 of process 300. In some exemplary embodiments, icons denoting, for example, a map may be placed next to a definition to indicate that the definition received a higher rank based on a location of client 110, 120 or user 112, 122. In other exemplary embodiments, icons to denote ranks based on a user's translation history or personal phrasebook may be displayed next to the definitions. For example, as shown in FIG. 4, window 410 displays “noun” as the part-of-speech for the phrase block “apple.” Additionally, window 410 displays two definitions of the word “apple.” As shown in FIG. 4, a first definition of “apple” as a fruit has a higher rank as compared to a second definition corresponding to an “apple-tree.” Therefore, window 410 displays the first definition of “apple,” and displays the second definition corresponding to the “apple-tree” below the first definition. As further illustrated in FIG. 4, window 410 also displays a usage example corresponding to each definition.

User interface 400 may also include window 412 for displaying translated text corresponding to a phrase block. Window 412 may be displayed below window 408 adjacent a lower right corner of display 250. Window 412 may display the translated text, in the target language, according to the second rank order determined, for example, in step 316 of process 300. Window 412 may also group items in the translated text based on parts-of-speech. Further, window 412 may display both the masculine and feminine forms in the translated text. For example, as shown in FIG. 4, window 412 displays two items, namely “la manzana,” which is the masculine form and “el manzano,” which is the feminine form under the part-of-speech “noun.” Window 412 may also include ranking graphic 414, which displays horizontal shaded boxes indicating a relative frequency of usage of each item in the translated text. For example, as shown in FIG. 4, usage of “la manzana” may be more frequent as compared to usage of “el manzano” as shown by the larger horizontal shaded box for “la manzana” in ranking graphic 414.

Windows 410 and 412 may also include graphical arrows 416. Clicking on graphical arrow 416 may allow a user to display additional definitions and usage examples in window 410 and additional translated text in window 412. It is to be understood that the arrangement of various portions of user interface 400, as described above, is exemplary and that these portions may be displayed in any order and may have a variety of shapes and sizes. Further, it is to be understood that user interface 400 is not limited to the display portions, windows, and graphics described above and may include more or less display portions, windows, graphical arrows, graphics, or other user interface elements.

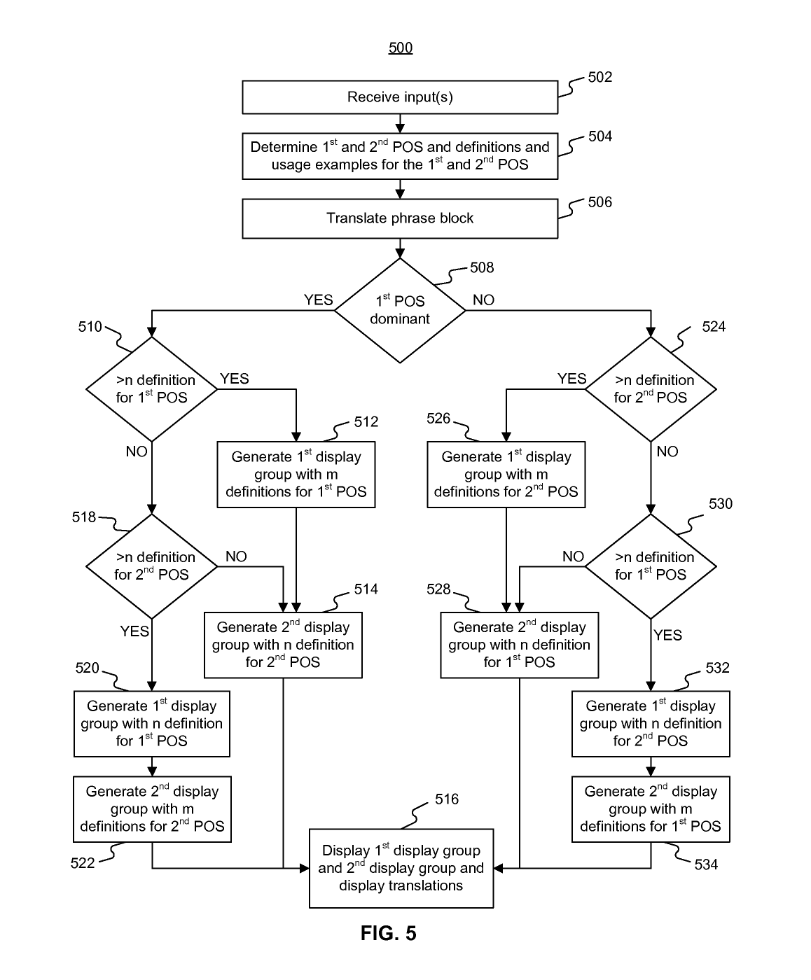

FIG. 5 is a flowchart of an exemplary process 500, consistent with embodiments of the present disclosure. As further described below, the exemplary process 500 of FIG. 5 may be implemented for displaying the definitions and translations of a phrase block, which may have two parts-of-speech. Process 500 may be implemented on a client 110 or 120 without the need to access server 140 and/or network 130. Additionally or alternatively, process 500 may be implemented on server 140 without the need to access clients 110, 120 and/or network 130. In some embodiments, process 500 may be implemented using one or more of clients 110, 120, and/or server 140 communicating via network 130. The order and arrangement of steps in process 500 is provided for purposes of illustration. As will be appreciated from this disclosure, modifications may be made to process 500 by, for example, adding, combining, removing, and/or rearranging the steps for the process.

As shown in FIG. 5, process 500 may include a step 502 of receiving input(s). Receiving inputs in step 502 may include receiving input of a phrase block for translation, receiving an indication of a source language, and/or receiving an indication of a target language. Receiving input of a phrase block in step 502 of process 500 may include processes similar to those described above with respect to step 302 of process 300. Receiving an indication of a source language and receiving an indication of a target language in step 502 of process 500 may include processes similar to those described above with respect to step 302 of process 300.

Process 500 may also include a step 504 of determining a first part-of-speech (1^{st} POS) and a second part-of-speech (2^{nd} POS) for the phrase block and determining definitions and usage examples for the 1^{st} and 2^{nd} POS. Determining the 1^{st} and 2^{nd} POS in step 504 may include processes similar to those described above with respect to step 304 of process 300. Further, determining definitions for each of the 1^{st} POS and 2^{nd} POS may include processes similar to those described above with respect to step 306 of step 300. Further still, determining usage examples corresponding to the definitions for each of the 1^{st} POS and 2^{nd} POS may include processes similar to those described above with respect to step 306 of process 300.

Process 500 may also include a step 506 of translating the phrase block received in step 502. Translating the phrase block in step 506 may include determining translated text corresponding to the phrase block for each of the 1^{st} POS and the 2^{nd} POS. Further, translating the phrase block for each of 1^{st} POS and 2^{nd} POS in step 506 may include processes similar to those described above with respect to step 308 of process 300.

Process 500 may also include a step 508 of determining whether the 1^{st} POS is dominant as compared to the 2^{nd} POS. Determining whether the 1^{st} POS is dominant may include determining a frequency of use of a phrase block corresponding to the 1^{st} POS in a corpus, translation history of the user, or textual content stored by the user. In one exemplary embodiment, 1^{st} POS may be determined to be dominant compared to 2^{nd} POS when the relative number of times the phrase block appears in the corpus with a meaning corresponding to the 1^{st} POS exceeds the number of time the phrase block appears with a meaning corresponding to the 2^{nd} POS. Determining whether 1^{st} POS is dominant may also include determining whether 1^{st} POS may be more frequently used at or near the location of user 112, 122 or client 120, 130. Determining whether 1^{st} POS is more dominant may include processes similar to those disclosed for ranking definitions with respect to step 310 of process 300.

When it is determined that 1^{st} POS is dominant (Step 508: YES), process 500 may proceed to step 510 of determining whether 1^{st} POS has more than n definitions. When it is determined in step 510 that 1^{st} POS has more than n definitions (Step 510: YES), process 500 may proceed to step 512 of generating a 1^{st} display group having m definitions (m>n) for the 1^{st} POS. Generating the 1^{st} display group may include ranking the definitions for the 1^{st} POS in a first rank order. Ranking the definitions for the 1^{st} POS in a first rank order may include processes similar to those described above with respect to step 310 of process 300. Generating the 1^{st} display group may also include selecting definitions having a higher rank in the first rank order. In one exemplary embodiment (n=1, m=2), generating the 1^{st} display group may include selecting two definitions including a first definition having the highest rank in the first rank order and a second definition having a second highest rank in the first rank order. Generating the 1^{st} display group may also include selecting one or more usage examples corresponding to each selected definition. Further, generating the 1^{st} display group may include ordering the selected definitions and usage examples such that the usage examples corresponding to a definition are displayed immediately below the definition. Ordering the definitions may also include arranging the definitions based on an ascending or descending order of their rank in the first rank order.

As shown in FIG. 5, process 500 may also include a step 514 of generating a second display group with n definitions selected from the definitions determined for the 2^{nd} POS. Generating the 2^{nd} display group may include ranking the definitions for the 2^{nd} POS in a second rank order. In one exemplary embodiment, generating the 2^{nd} display group may include selecting n definitions having the highest ranks in the second rank order and selecting one or more usage examples corresponding to each of the n definitions.

Process 500 may also include a step 516 of displaying the 1^{st} and 2^{nd} display groups on a display. In one exemplary embodiment, displaying the 1^{st} and 2^{nd} display groups may include displaying the 1^{st} display group above the 2^{nd} display group on a display for presentation to the user.

Returning to step 510, when it is determined that n definitions exist for the 1^{st} POS (Step 510: NO), process 500 may proceed to step 518 of determining whether 2^{nd} POS has more than n definitions. When it is determined that 2^{nd} POS has more than n definitions (Step 518: YES), process 500 may proceed to a step 520 of generating a 1^{st} display group with n definitions for the 1^{st} POS. Generating the 1^{st} display group in step 520 may include ranking the definitions for 1^{st} POS in a first rank order. In one exemplary embodiment, generating the 1^{st} display group may include selecting n definitions having the highest ranks in the first rank order and selecting one or more usage examples corresponding to each of the n definitions for the 1^{st} POS.

Process 500 may also include a step 522 of generating a second display group with m definitions selected from the definitions determined for the 2^{nd} POS. Generating the 2^{nd} display group in step 522 may include ranking the definitions for the 2^{nd} POS in a second rank order. In one exemplary embodiment (n=1, m=2), generating the 2^{nd} display group may include selecting two definitions including a first definition having the highest rank in the second rank order and a second definition having a second highest rank in the second rank order. Generating the 2^{nd} display group may also include including one or more usage examples corresponding to each selected definition. Further, generating the 2^{nd} display group may include ordering the selected definitions and usage examples such that the usage examples corresponding to a definition are displayed immediately below the definition. Further, the definitions may be arranged in an ascending or descending order of their rank in the first rank order. Process 500 may then proceed to step 516 of displaying the 1^{st} display group and the second display group.

Returning to step 518, when it is determined that the 2^{nd} POS has n definitions (Step 518: NO), process 500 may proceed to step 514 of generating the 2^{nd} display group with n definitions for the 2^{nd} POS. Process 500 may then proceed to step 516 of displaying the 1^{st} display group and the 2^{nd} display group.

Returning to step 508, when it is determined that 1^{st} POS is not dominant (Step 508: NO), process 500 may proceed to step 524 of determining whether 2^{nd} POS has more than n definitions. When it is determined in step 524 that 2^{nd} POS has more than n definitions (Step 524: YES), process 500 may proceed to step 526 of generating a 1^{st} display group including m definitions (m>n) for the 2^{nd} POS. Generating the 1^{st} display group may include ranking the definitions for the 2^{nd} POS in a first rank order. Ranking the definitions for the 2^{nd} POS in a first rank order may include processes similar to those described above with respect to step 310 of process 300. Generating the 1^{st} display group may also include selecting m definitions for the 2^{nd} POS having a higher rank in the first rank order. In one exemplary embodiment (n=1, m=2), generating the 1^{st} display group may include selecting two definitions for the 2^{nd} POS, including a first definition having the highest rank in the first rank order and a second definition having a second highest rank in the first rank order. Generating the 1^{st} display group may also include including one or more usage examples corresponding to each selected definition. Further, generating the 1^{st} display group may include ordering the selected definitions and usage examples such that the usage examples corresponding to a definition are displayed immediately below the definition. Further the definitions may be arranged based on an ascending or descending order of their rank in the first rank order.

As shown in FIG. 5, process 500 may also include a step 528 of generating a 2^{nd} display group with n definitions selected from the definitions determined for the 1^{st} POS. Generating the 2^{nd} display group may include ranking the definitions for the 1^{st} POS in a second rank order. In one exemplary embodiment, generating the 2^{nd} display group may include selecting n definitions having the highest ranks in the second rank order and selecting one or more usage examples corresponding to each of the n definitions.

Process 500 may also include a step 516 of displaying the 1^{st} and 2^{nd} display groups on a display. Displaying the 1^{st} and 2^{nd} display groups may include displaying the 1^{st} display group above the 2^{nd} display group on a display for presentation to the user.

Returning to step 524, when it is determined that 2^{nd} POS has n definitions (Step 524: NO), process 500 may proceed to step 530 of determining whether 1^{st} POS has more than n definitions. When it is determined that 1^{st} POS has more than n definitions (Step 530: YES), process 500 may proceed to a step 532 of generating a 1^{st} display group with n definition for the 2^{nd} POS. Generating the 1^{st} display group in step 532 may include ranking the definitions for the 2^{nd} POS in a first rank order. In one exemplary embodiment, generating the 1^{st} display group may include selecting in definitions having the highest ranks in the first rank order and selecting one or more usage examples corresponding to each of the n definitions for the 2^{nd} POS.

Process 500 may also include a step 534 of generating a second display group with m definitions (m>n) selected from the definitions determined for the 1^{st} POS. Generating the 2^{nd} display group in step 534 may include ranking the definitions for the 1^{st} POS in a second rank order. In one exemplary embodiment (n=1, m=2), generating the 2^{nd} display group may include selecting two definitions including a first definition having the highest rank in the second rank order and a second definition having a second highest rank in the second rank order. Generating the 2^{nd} display group may also include including one or more usage examples corresponding to each selected definition. Further, generating the 2^{nd} display group may include ordering the selected definitions and usage examples such that the usage examples for a definition are displayed immediately below the definition. Further the definitions may be arranged based on an ascending or descending order of their ranks in the first rank order. Process 500 may then proceed to step 516 of displaying the 1^{st} display group and the 2^{nd} display group.

Returning to step 530, when it is determined that 1^{st} POS has n definitions (Step 530: NO), process 500 may proceed to step 528 of generating the 2^{nd} display group with n definitions for the 1^{st} POS. Process 500 may then proceed to step 516 of displaying the 1^{st} display group and the 2^{nd} display group.

In the above description, the number of definitions n and m may take any value so long as m is larger than n. In one exemplary embodiment, n may be 1, m may be 2, and only one usage example may be provided for each selected definition.

Step 516 of process 500 may also include displaying the translations for the phrase block grouped by each part-of-speech. Further, the translations corresponding to each part-of-speech may be ordered using processes similar to those described above with respect to step 308 of process 300. For example, a 1^{st} translation display group may include translated text corresponding to the 1^{st} POS and a 2^{nd} translation display group may include translated text corresponding to the 2^{nd} POS. The 1^{st} and 2^{nd} translation display groups may be displayed in any order on the display. In one exemplary embodiment, the 1^{st} and 2^{nd} translation display groups may be displayed in an order based on whether the 1^{st} POS or the 2^{nd} POS is dominant. For example, if the 1^{st} POS is dominant compared to the 2^{nd} POS, the 1^{st} translation display group may be displayed above the 2^{nd} translation display group.

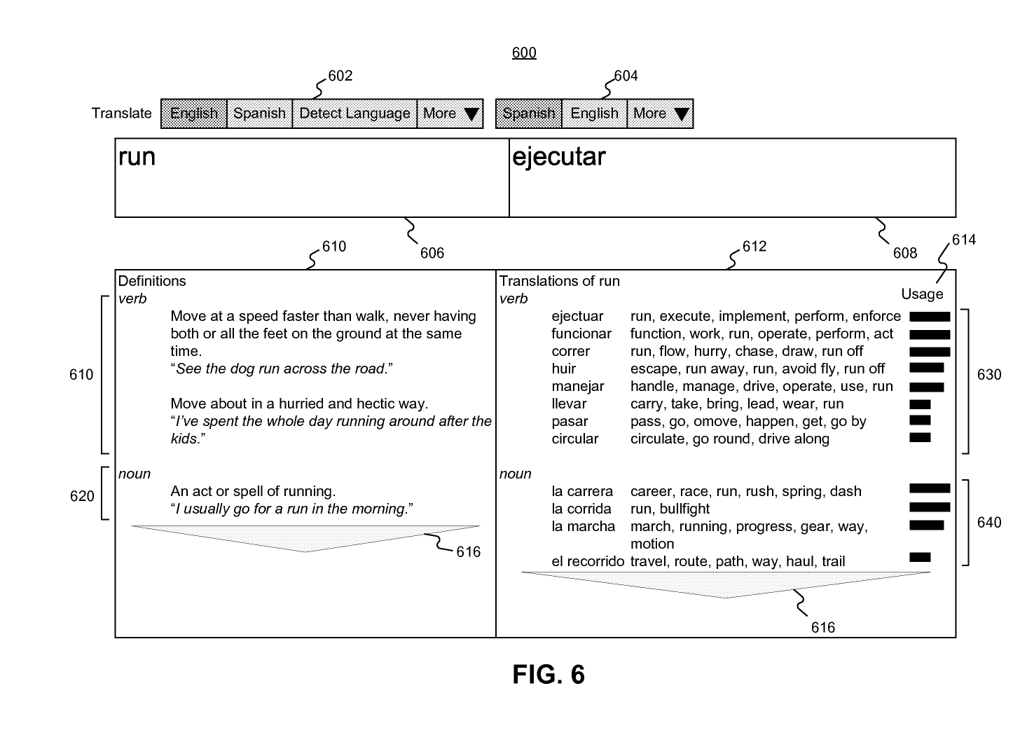

FIG. 6 illustrates an exemplary user interface 600. User interface 600, shown in FIG. 6, shows the definitions and translations of a phrase block for a case where m=2 and n=1. Display portions 602, 604, windows 606, 608, 610, 612, graphical arrows 616, and usage graphic 614 have similar structures and functions as described above with respect to the corresponding elements of FIG. 4. Windows 610 and 612 in FIG. 6 display definitions, usage examples, and translations based on the process described above with respect to process 500. FIG. 6 illustrates an example where the 1^{st} POS is dominant (Step 508: YES) and has more than one definition (Step 510: YES).

For example, as illustrated in FIG. 6, the input phrase block “run” is shown in window 606. The phrase block “run” has two parts-of-speech, namely verb (1^{st} POS) and noun (2^{nd} POS). FIG. 6 illustrates an example where the 1^{st} POS (“verb”) is dominant (Step 508: YES) as compared to 2^{nd} POS (“noun”) and where 1^{st} POS has more than one definition (Step 510: YES). As illustrated in FIG. 6, according to step 512 of process 500, the 1^{st} display group 610 includes a first definition: “Move at a speed faster than walk, never having both or all feet on the ground at the same time” and a second definition: “Move about in a hurried and hectic way.” As further illustrated in FIG. 6, the first definition in 1^{st} display group 610 is arranged above the second definition because the first definition has a higher rank compared to the second definition. As also illustrated in FIG. 6, each of the first and second definitions for the part-of-speech “verb” has a usage example. For example, the usage example for the first definition reads “See the dog run across the road” and the usage example for the second definition reads “I've spent the whole day running around after the kids.”

FIG. 6 also illustrates the 2^{nd} display group 620 for the non-dominant 2^{nd} POS (“noun”) according to step 514 of process 500. As illustrated in FIG. 6, the 2^{nd} display group 620 has one definition: “An act or spell of running” and one usage example: “I usually go for a run in the morning.” FIG. 6 also illustrates that the 1^{st} display group 610 is displayed above the 2^{nd} display group 620 because the 1^{st} POS is dominant compared to the 2^{nd} POS.

FIG. 6 further illustrates translated text for the phrase block “run.” As illustrated in window 612 of FIG. 6, items in the translated text are grouped by parts-of-speech. Thus, for example, window 612 of FIG. 6 shows a first translation display group 630 and a second translation display group 640. Items “ejectuar,” “funcionar,” “correr,” etc., grouped under the 1^{st} POS (“verb”) are arranged in first translation display group 630. Items “la carrera,” “la corrida,” “la marcha,” and “el recorrido” grouped under the 2^{nd} POS (“noun”) are arranged in second translation display group 640. As illustrated in FIG. 6, first translation group 630 is displayed above second translation display group 640. In addition, FIG. 6 displays ranking graphic 614, which shows the relative usage frequency of each item in the translated text. FIG. 6 also shows in window 608, translated text item “ejecutar” because it has the highest relative usage frequency for the dominant part-of-speech, which in this example is “verb.”

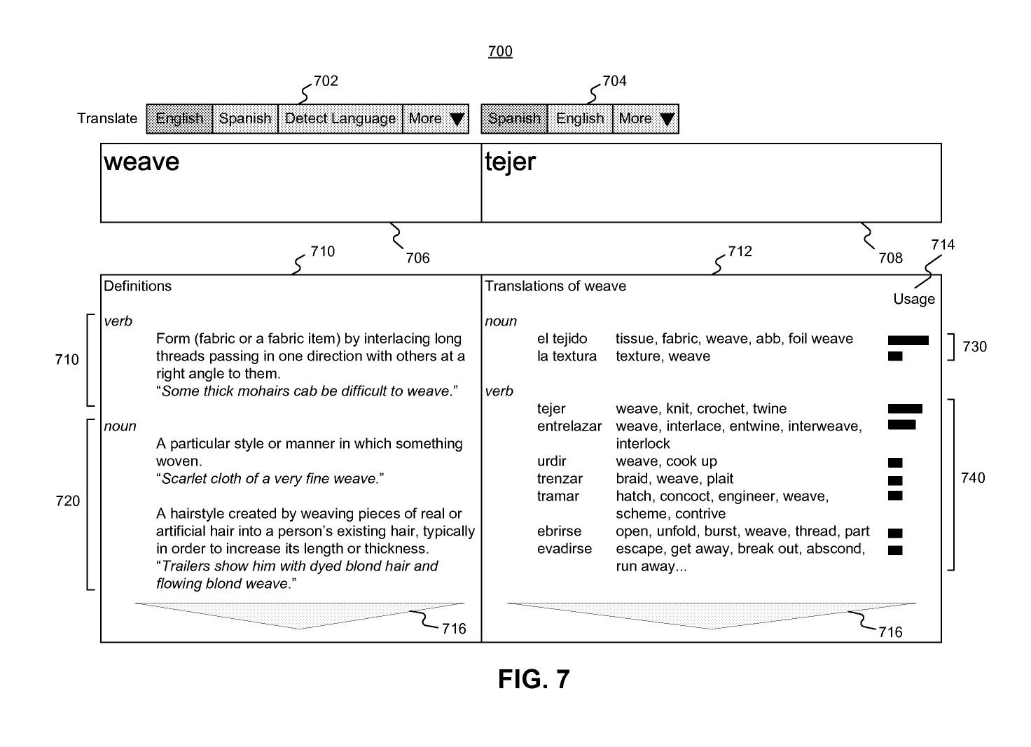

FIG. 7 illustrates an exemplary user interface 700. User interface 700, shown in FIG. 7, shows the definitions and translations of a phrase block when there are two parts-of-speech associated with the phrase block. As illustrated in FIG. 7, display portions 702, 704, windows 706, 708, 710, 712, graphical arrows 716, and usage graphic 714 have similar structures and functions as described above with respect to the corresponding elements in FIG. 4. Windows 710 and 712 in FIG. 7 display definitions, usage examples, and translations based on the process described above with respect to process 500. FIG. 7 illustrates an example where the 1^{st} POS is dominant (Step 508: YES) and has only one definition (Step 510: NO).

For example, as illustrated in FIG. 7, the input phrase block “weave” is shown in window 706. The phrase block “weave” has two parts-of-speech, namely verb (1^{st} POS) and noun (2^{nd} POS). FIG. 7 illustrates an example where the 1^{st} POS (“verb”) is dominant (Step 508: YES) as compared to 2^{nd} POS (“noun”) and where 1^{st} POS has only one definition (Step 510: NO). As illustrated in FIG. 7, according to step 520 of process 500, the 1^{st} display group 710 includes one definition: “Form (fabric or a fabric item) by interfacing long threads in one direction with others at a right angle to them” and one usage example; “Some thick mohairs can be difficult to weave.”

FIG. 7 also illustrates the 2^{nd} display group 720 for the non-dominant 2^{nd} POS (“noun”) according to step 522 of process 500. As illustrated in FIG. 7, the 2^{nd} display group displays two definitions, a first definition: “A particular style or manner in which something is woven,” and a second definition: “A hairstyle created by weaving pieces of real or artificial hair into a person's existing hair, typically in order to increase its length of thickness.” As further illustrated in FIG. 7, the first definition in 2^{nd} display group 720 is arranged above the second definition because the first definition has a higher rank compared to the second definition. As also illustrated in FIG. 7, each of the first and second definitions for the part-of-speech “noun” has a usage example. For example, the usage example for the first definition reads “Scarlet cloth of a very fine weave” and the usage example for the second definition reads “Trailers show him with dyed blond hair and flowing blond weave.” FIG. 7 also illustrates that the 1^{st} display group 710 is displayed above the 2^{nd} display group 720 because the 1^{st} POS is dominant compared to the 2^{nd} POS. As further illustrated in FIG. 7, a usage example corresponding to each definition is displayed immediately below the corresponding definition.

FIG. 7 further illustrates translated text for the phrase block “weave.” As illustrated in window 712 of FIG. 7, the translations are grouped by parts-of-speech. Thus, for example, window 712 of FIG. 7 shows a first translation display group 730 and a second translation display group 740. Items “el tejido,” and “la textura,” under the 2^{nd} POS (“noun”) are arranged in first translation display group 730. Items “tejer,” “entrelazar,” etc., grouped under the 1^{st} POS (“verb”) are arranged in second translation display group 740. As illustrated in FIG. 7, first translation display group 730 is displayed above second translation display group 740. In addition, FIG. 7 displays ranking graphic 714, which shows the relative usage frequency of each translation. FIG. 7 also shows in window 708, the translated text item “tejer” because it has the highest relative usage frequency for the dominant part-of-speech, which in this example is “verb.”

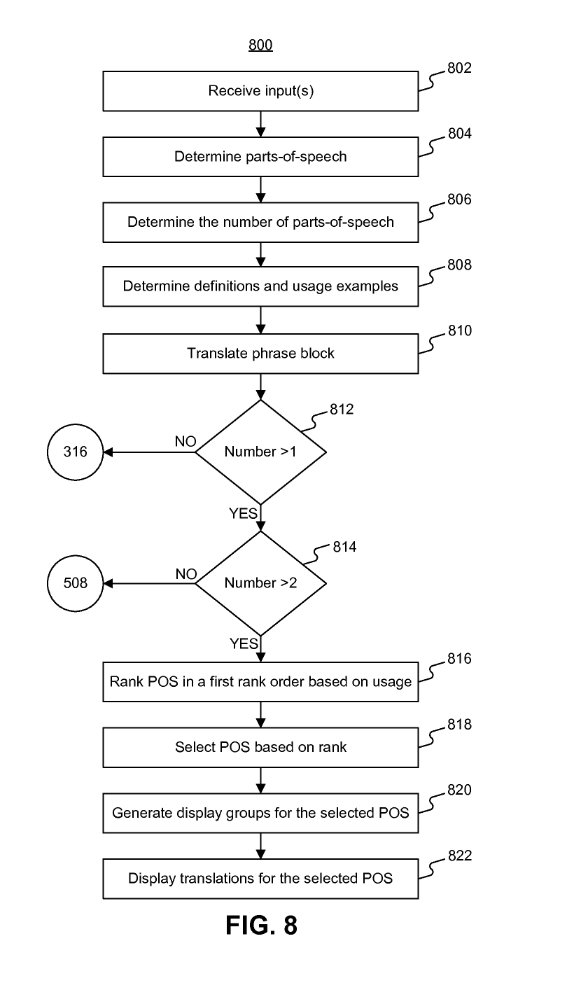

FIG. 8 is a flowchart of an exemplary process 800, consistent with embodiments of the present disclosure. As further described below, the exemplary process 800 of FIG. 8 may be implemented for displaying the meanings and translations of a phrase block, which may have more than two parts-of-speech. Process 800 may be implemented on a client 110 or 120 without the need to access server 140 and/or network 130. Additionally or alternatively, process 800 may be implemented on server 140 without the need to access clients 110, 120 and/or network 130. In some embodiments, process 800 may be implemented using one or more of clients 110, 120, and/or server 140 communicating via network 130. The order and arrangement of steps in process 800 is provided for purposes of illustration. As will be appreciated from this disclosure, modifications may be made to process 800 by, for example, adding, combining, removing, and/or rearranging the steps for the process.

As shown in FIG. 8, process 800 may include a step 802 of receiving input(s). Receiving input(s) in step 802 may include receiving input of a phrase block for translation, receiving an indication of a source language, and/or receiving an indication of a target language. Receiving input of a phrase block in step 802 may include processes similar to those described above with respect to step 302 of process 300. Receiving an indication of a source language and receiving an indication of a target language in step 802 of process 800 may include processes similar to those described above with respect to step 302 of process 300.

Process 800 may also include a step 804 of determining the parts-of-speech for the phrase block and determining definitions and usage examples for all the parts-of-speech. Determining the parts-of-speech in step 804 may include processes similar to those described above with respect to step 304 of process 300. Process 800 may also include a step 806 of determining the number of parts-of-speech (i.e. how many parts-of-speech?) for the phrase block.

Process 800 may also include a step 808 of determining definitions and usage examples for the parts-of-speech. Determining definitions for the parts-of-speech may include processes similar to those described above with respect to step 306 of step 300. Further, determining usage examples corresponding to the definitions for the parts-of-speech may include processes similar to those described above with respect to step 306 of process 300.

Process 800 may also include a step 810 of translating the phrase block received in step 802. Translating the phrase block in step 810 may include determining translated text corresponding to the phrase block for each of the parts-of-speech determined, for example, in step 804. Further, translating the phrase block in step 810 may include processes similar to those described above with respect to step 308 of process 300.

Process 800 may also include a step 812 of determining whether the number of parts-of-speech exceeds 1 (one). When it is determined in step 812 that the number of parts-of-speech for the phrase block does not exceed 1 (Step 812: NO), process 800 may proceed to step 316 of process 300 and continue through steps 318 and 320 of process 300. When it is determined in step 812 that the number of parts-of-speech for the phrase block exceeds 1 (Step 812: YES), process 800 may proceed to step 814 of determining whether the number of parts-of-speech for the phrase block exceeds 2 (two).

When it is determined in step 814 that the number of parts-of-speech for the phrase block does not exceed 2 (Step 814: NO), process 800 may proceed to step 508 of process 500, and continue through the remaining steps in process 500. When it is determined in step 814 that the number of parts-of-speech for the phrase block exceeds 2 (Step 814: YES), process 800 may proceed to step 816 of ranking the parts-of-speech in a first rank order. Ranking the parts-of-speech (POS) in step 816 may include processes similar to those described above for step 508 of process 500.

Process 800 may include a step 818 of selecting parts-of-speech based on the rank order determined in step 816. Selecting parts-of-speech may include selecting parts-of-speech having a higher rank. In one exemplary embodiment, step 818 may include selecting three parts-of-speech including a first part-of-speech having the highest rank, a second part-of-speech having the second highest rank, and a third part-of-speech having a third highest rank. In another exemplary embodiment, any number of parts-of-speech may be selected in an ascending or descending order of their rank in the first rank order.

Process 800 may include a step 820 of displaying the selected parts-of-speech with definitions and usage examples. Displaying the parts-of-speech and usage examples may include showing a first part-of-speech having the highest rank on top. One or more definitions corresponding to the first part-of-speech may be displayed below the first part-of speech. One or more usage examples corresponding to each displayed definition may be displayed below each corresponding definition. Further, a second part-of-speech having a next lower rank may be displayed below the last usage example for the first part-of-speech. Additionally, one or more definitions corresponding to the second part-of-speech may be displayed below the second part-of speech. Further, one or more usage examples corresponding to each displayed definition may be displayed below the corresponding definition. Additional parts-of-speech and usage examples may be displayed in a similar manner below the last usage example for the second part-of-speech according to a descending order of rank of the parts-of-speech. The definitions corresponding to each displayed part-of-speech may be ordered using processes similar to those described above with respect to steps 512, 522, 526, and 534 of process 500. In one exemplary embodiment, only three parts-of-speech having the highest three ranks, with one most dominant (i.e. highest ranked) definition for each of the three parts-of-speech, and one usage example for each definition may be displayed.

Process 800 may also include a step 822 of displaying translated text for the parts-of-speech selected for display in step 820. The items in the translated text may be ordered and displayed using processes similar to those described above with respect to step 516 of process 500.

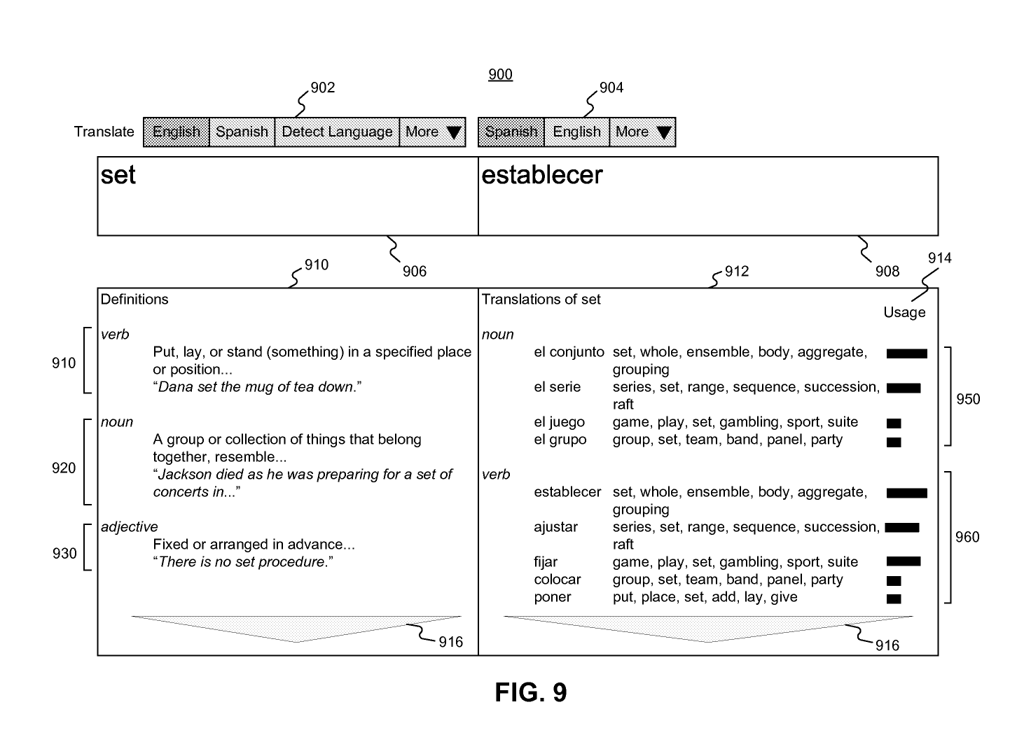

FIG. 9 illustrates an exemplary user interface 900, showing the definitions and translations of a phrase block when there are two parts-of-speech associated with the phrase block. As illustrated in FIG. 9, display portions 902, 904, windows 906, 908, 910, 912, graphical arrows 916, and usage graphic 914 have similar structures and functions as described above with respect to the corresponding elements in FIG. 4. Windows 910 and 912 in FIG. 9 display definitions, usage examples, and translations based on the process described above with respect to process 800.

For example, as illustrated in FIG. 9, the input phrase block “set” is shown in window 906. The phrase block “set” has three parts-of-speech, namely verb (1^{st} POS), noun (2^{nd} POS), and adjective (3^{rd} POS). FIG. 9 illustrates an example where the 1^{st} POS (“verb”) is most dominant, 3^{rd} POS (“adjective”) is the least dominant, and 2^{nd} POS (“noun”) is less dominant than the 1^{st} POS and more dominant than the 3^{rd} POS. As illustrated in FIG. 9, according to step 822 of process 800, the 1^{st} display group 910 includes one definition for 1^{st} POS (“verb”): “Put, lay, or stand (something) in a specified place or position” and one usage example: “Dana set the mug of tea down.” As further illustrated in FIG. 9, according to step 822 of process 800, the 2^{nd} display group 920 includes one definition for 2^{nd} POS (“noun”): “A group or collection of things that belong together, resemble . . . ” and one usage example: “Jackson died as he was preparing for a set of concerts in . . . . ” As also illustrated in FIG. 9, according to step 822 of process 800, the 3rd display group 930 includes one definition for 3rd POS (“adjective”): “Fixed or arranged in advance . . . ” and one usage example: “There is no set procedure.” As shown in FIG. 9, the 1^{st}, 2^{nd}, and 3^{rd} display groups are displayed one below the other in descending order of rank of the 1^{st}, 2^{nd}, and 3^{rd}, parts-of-speech.

FIG. 9 further illustrates translations for the phrase block “weave.” As illustrated in window 912 of FIG. 9, the translations are grouped by parts-of-speech. Thus, for example, window 912 of FIG. 9 shows a first translation display group 950 and a second translation display group 960. Items “el conjunto,” “el serie,” etc., under the 2^{nd} POS (“noun”) are arranged in first translation display group 950. Items “establecer,” “adjustar,” etc., grouped under the 1^{st} POS (“verb”) are arranged in second translation display group 960. As illustrated in FIG. 9, first translation display group 950 is displayed above second translation display group 960. Items corresponding to 3^{rd} POS (“adjective”) are not shown in FIG. 9. In some exemplary embodiments, a user can unfold additional translated text for “verb” or translated text corresponding to the 3^{rd} POS (“adjective”) by clicking on graphical arrow 916 using, for example, a computer mouse or one or more of the I/O devices 220. FIG. 9 also displays ranking graphic 914, which shows the relative usage frequency of each translation. FIG. 9 also shows in window 908, the translation “establecer” because it has the highest relative usage frequency for the dominant part-of-speech, which in this example is “verb.”

Other embodiments of the disclosure will be apparent to those skilled in the art from consideration of the specification and practice of the embodiments disclosed herein. It is intended that the specification and examples be considered as exemplary only, with a true scope and spirit of the invention and exemplary embodiments being indicated by the following claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present disclosure.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A server system for translating a phrase block, the system comprising:
a memory device that stores a set of instructions; and
one or more processors that execute the instructions to:
receive a request for translation, the request comprising a phrase block;
identify parts of speech of the phrase block;
determine definitions of the phrase block, corresponding to the identified parts of speech, in the source language;
determine usage examples for the phrase block, corresponding to the definitions, in the source language;
translate, the phrase block from the source language to translated text in the target language, the translated text comprising one or more translations of the phrase block
rank the parts of speech in a first rank order based on usage of the parts of speech in the source language;
generate display groups, each group including a part of speech selected from the parts of speech, one or more definition corresponding to the part of speech, and one or more usage examples corresponding to the definitions;
determine the order for the display groups based on the first rank order; and
transmit information sufficient for a device to render the display groups in the order and the translated text.

2. The server system of claim 1, wherein to generate the display groups the server:
ranks the definitions corresponding to the part of speech in a second rank order based on usage of the definitions in the source language; and
arranges the definitions in the each display group according to the second rank order.

3. The server system of claim 2, wherein the instructions further cause the one or more processors of the server to:
determine a location of the client; and
determine the usage of the definitions based on the location.

4. The server system of claim 2, wherein the instructions further cause the one or more processors of the server to:
retrieve textual content containing the phrase block stored on the client; and
determine, in the textual content, frequencies of use of the phrase block according to the definitions; and
rank the definitions based on the frequencies of use.

5. The server system of claim 2, wherein the instructions further cause the one or more processors of the server to:
rank items in the translated text, corresponding to the part of speech, in a third rank order based on usage of the items in the target language; and
arrange the items according to the third rank order.

6. The server system of claim 5, wherein the instructions further cause the one or more processors of the client to:
display a ranking graphic representing a rank of an item in the translated text as determined in the third rank order.

7. The server system of claim 6, wherein the instructions further cause the one or more processors of the client to:
display the display groups in a first window of the display; and
display the translated text in a second window of the display.

8. The server system of claim 7, wherein the instructions further cause the one or more processors of the client to:
display a first graphical arrow in the first window;
display a second graphical arrow in the second window;
unfold the first window to reveal more display groups when the user accesses at least one of the first graphical arrow and the second graphical arrow.

9. A computer-implemented method of translating a phrase block, the method comprising the following operations performed by one or more processors:
receiving, from a client device, a phrase block for translation from a source language to a target language;
identifying a part of speech for the phrase block;
determining a definition of the phrase block in the source language, the definition corresponding to the part of speech;
determining a usage example for the phrase block in the source language, the usage example corresponding to the definition;
translating the phrase block from the source language to translated text in the target language, the translated text corresponding to the part of speech; and
generating a display of the phrase, the part of speech, the definition, the usage example, and the translated text.

10. The computer-implemented method of claim 9, wherein the definition is a first definition, the usage example is a first usage example, and the method further includes:
determining a second definition of the phrase block in the source language, the second definition corresponding to the part of speech;
determining a second usage example for the phrase block in the source language, the second usage example corresponding to the second definition;
ranking the first definition and the second definition in a first rank order based on usage of the phrase block in the source language; and
displaying the first definition, the first usage example, the second definition, and the second usage example based on the first rank order.

11. The computer-implemented method of claim 10, further including:
determining a location of the client device; and
determining the usage of the definitions based on the location.

12. The computer-implemented method of claim 10, further including:
retrieving textual content containing the phrase block from content stored on the client device; and
determining the usage of the definitions based on the textual content.

13. The computer-implemented method of claim 10, wherein determining usage includes:
accessing content from a corpus;
identifying target content containing the phrase block in the corpus;
determining a first frequency of use of the phrase block, in the target content, according to the first definition;
determining a second frequency of use of the phrase block, in the target content, according to the second definition; and
ranking the first definition and the second definition based on the first frequency and the second frequency.

14. The computer-implemented system of claim 13, wherein the corpus includes at least one of documents, search logs, web pages, and social network content.

15. The computer-implemented method of claim 10, wherein:
ranking further includes:
generating a first display group including the first definition, and the first usage example;
generating a second display group including the second definition, and the second usage example; and
displaying further includes:
displaying the first display group and the second display group based on the first rank order.

16. The computer-implemented method of claim 9, further including:
determining definitions of the phrase block in the source language, the definitions corresponding to the part of speech;
determining usage examples for the phrase block in the source language, the usage examples corresponding to the definitions;
ranking the definitions in a first rank order based on usage of the definitions in the source language;
generating display groups, each display group including:
a definition selected from the definitions; and
a usage example selected from the usage examples, the usage example corresponding to the definition; and
displaying the display groups based on the first rank order.

17. The computer-implemented method of claim 16, further including:
ranking items in the translated text in a second rank order based on usage of the translated text in the target language;
displaying the items based on the second rank order.

18. The computer-implemented method of claim 17, further including displaying two display groups on the display.

19. A computer-implemented method of translating a phrase block, the method comprising the following operations performed by one or more processors:
receiving a phrase block for translation from a source language to a target language;
identifying parts of speech corresponding to the phrase block;
determining definitions of the word in the source language corresponding to the parts of speech;
determining usage examples for the word in the source language corresponding to the definitions;
translating the phrase block from the source language to translated text, corresponding to the parts of speech, in the target language;
ranking the parts of speech in a first rank order based on usage of the parts of speech in the source language;
generating display groups, each display group including:
a part of speech selected from the parts of speech;
definitions corresponding to the part of speech;
usage examples corresponding to the definitions; and
presenting, on a display device, the phrase block, and the display groups based on the first rank order.

20. The computer-implemented method of claim 19, wherein generating display groups further includes:
ranking the definitions corresponding to the part of speech in a second rank order based on usage of the definitions; and
arranging the definitions in the each display group according to the second rank order.

21. The computer-implemented method of claim 20, wherein generating display groups further includes:
ranking items in the translated text, corresponding to the part of speech, in a third rank order based on usage of the items in the target language; and
arranging the items in the each display group according to the third rank order.

22. The computer-implemented method of claim 21, further comprising:
displaying a ranking graphic representing a rank of each item in the translated text as determined in the third rank order.

23. The computer-implemented method of claim 19, further comprising:
displaying the display groups in a first window of the display; and
displaying the translated text in a second window of the display.

24. The computer implemented method of claim 20, further comprising:
displaying a first graphical arrow in the first window;
displaying a second graphical arrow in the second window; and
unfolding the first window to reveal more display groups when the user accesses at least one of the first graphical arrow and the second graphical arrow.

25. The computer-implemented method of claim 20, wherein the each display group includes:
two definitions including:
a first definition having a highest rank in the second rank order; and
a second definition having a second highest rank in the second rank order; and
one usage example corresponding to each of the first definition and the second definition.

26. The computer-implemented method of claim 20, further including determining a number of parts of speech for the word.

27. The computer implemented method of claim 26, further including:
displaying one display group when the number of parts of speech is one;
displaying two display groups when the number of parts of speech is two; and
displaying three display groups when the number of parts of speech exceeds two.

28. The computer implemented method of claim 27, wherein the one display group includes:
two definitions including:
a first definition having a highest rank in the second rank order; and
a second definition having a second highest rank in the second rank order; and
one usage example corresponding to each of the first definition and the second definition.

29. The computer implemented method of claim 27, wherein:
a first display group in the two display groups includes a first part of speech having a first rank in the first rank order;
a second display group in the two display groups includes a second part of speech having a second rank in the first rank order, the second rank being lower than the first rank; and
the method further includes:
determining a first number of definitions in the first display group; and
determining a second number of definitions in the second display group.

30. The computer implemented method of claim 27, wherein when the number of parts of speech exceeds two, each of the three display groups includes at most one definition.

31. A computer program product comprising executable instructions tangibly embodied in a non-transitory computer-readable medium, which when executed by one or more processors, cause the one or more processors to perform a method comprising:
receiving a phrase block for translation from a source language to a target language;
identifying parts of speech corresponding to the phrase block;
determining definitions of the word in the source language corresponding to the parts of speech;
determining usage examples for the word in the source language corresponding to the definitions;
translating the phrase block from the source language to translated text in the target language, corresponding to the parts of speech;
ranking the parts of speech in a first rank order based on usage of the parts of speech in the source language;
generating display groups, each display group including:
a part of speech selected from the parts of speech;
definitions corresponding to the part of speech;
usage examples corresponding to the definitions; and
presenting, on a display device, the phrase block, and the display groups based on the first rank order.

32. A client for translating a phrase block, the client comprising:
a memory device that stores a set of instructions; and
one or more processors that execute the instructions to:
receive a request for translation, the request comprising a phrase block;
identify parts of speech of the phrase block;
determine definitions of the phrase block, corresponding to the identified parts of speech, in the source language;
determine usage examples for the phrase block, corresponding to the definitions, in the source language;
translate, the phrase block from the source language to translated text in the target language, the translated text comprising one or more translations of the phrase block
rank the parts of speech in a first rank order based on usage of the parts of speech in the source language;
generate display groups, each group including a part of speech selected from the parts of speech, one or more definition corresponding to the part of speech, and one or more usage examples corresponding to the definitions;
determine the order for the display groups based on the first rank order; and
render, on a display device, the display groups in the order and the translated text.

33. The client of claim 32, wherein the instructions further cause the one or more processor to:
rank the definitions corresponding to the part of speech in a second rank order based on usage of the definitions in the source language; and
arranges the definitions in the each display group according to the second rank order.

34. The client claim 33, wherein the instructions further cause the one or more processors to:
retrieve textual content containing the phrase block stored on the client; and
determine, in the textual content, frequencies of use of the phrase block according to the definitions; and
rank the definitions based on the frequencies of use.

35. The client of claim 34, wherein the instructions further cause the one or more processors of the server to:
rank items in the translated text, corresponding to the part of speech, in a third rank order based on usage of the items in the target language; and
arrange the items according to the third rank order.

36. The client of claim 35, wherein the instructions further cause the one or more processors of the client to:
display a ranking graphic representing a rank of an item in the translated text as determined in the third rank order.

37. The client of claim 36, wherein the instructions further cause the one or more processors of the client to:
display the display groups in a first window of the display; and
display the translated text in a second window of the display.
